(19) United States
(12) Patent Application Publication
(10) Pub. No.: US 2023/0038743 A1
(43) Pub. Date: Feb. 9, 2023

(54) LIDAR SYSTEM USING LIGHT SOURCE HAVING DIFFERENT WAVELENGTHS

(71) Applicant: HL Klemove Corp., Incheon (KR)

(72) Inventors: YUN KI HAN, Suwon-si (KR); HoSeok SHIN, Suwon-si (KR); HakGu HAN, Namyangju-si (KR); Yong Min PARK, Seongnam-si (KR); Hyuk RYU, Seoul (KR)

(73) Assignee: HL Klemove Corp., Incheon (KR)

(21) Appl. No.: 17/881,791

(22) Filed: Aug. 5, 2022

(30) Foreign Application Priority Data
Aug. 6, 2021 (KR) 10-2021-0103700
Dec. 15, 2021 (KR) 10-2021-0179746

(51) Int. Cl. G02B 27/10; G01S 7/481; G02B 27/14; G01S 7/487

(52) U.S. Cl. CPC G02B 27/1006; G01S 7/481; G01S 7/487; G02B 27/14

(57) ABSTRACT

The present invention relates to a light detection and ranging (LiDAR) system. The LiDAR system may include a transceiver configured to generate pieces of light having different wavelengths and receive pieces of reflected light having different wavelengths reflected from a target, a beam splitter configured to divide the pieces of light having the different wavelengths into long-wavelength light having a relatively long wavelength and short-wavelength light having a relatively short wavelength, and a scan mirror configured to transmit the long-wavelength light and the short-wavelength light, which are divided by the beam splitter, to an outside and allow reflected light of the long-wavelength light and reflected light of the short-wavelength light to be incident on the transceiver through the beam splitter.

### CROSS-REFERENCE TO RELATED APPLICATION

This application claims priority to and the benefit of Korean Pat. Application No. 2021-0103700, filed on Aug. 6, 2021 and 2021-0179746, filed on Dec. 15, 2021, the disclosure of which is incorporated herein by reference in its entirety.

### BACKGROUND

### 1. Field of the Invention

The present invention relates to a light detection and ranging (LiDAR) system, and more particularly, to a LiDAR system using laser light having different wavelengths.

### 2. Discussion of Related Art

In general, light detection and ranging (LiDAR) is technology for detecting a distance to an object by measuring a time-of-flight (ToF) taken for laser light that is transmitted from a transmitter, is reflected by the object, and returns to a receiver.

In particular, a LiDAR sensor module may be applied to autonomous vehicles, autonomous drones, or the like and used to detect surrounding obstacles.

A LiDAR system usually scans a periphery using a light source having a single wavelength and receives reflected light of the light having a single wavelength to detect surrounding obstacles.

However, when other LiDAR systems are positioned around the LiDAR system and each detect obstacles using light in the same wavelength band, there has been a problem that interference may occur in the operation of the LiDAR system.

That is, noise is generated in three-dimensional (3D) point cloud data, which is a collection of points in a 3D space, and an overall signal-to-noise ratio (SNR) is lowered so that a total measurement distance may be reduced, noise may be recognized, and other functional errors may occur.

In addition, in a LiDAR system having a single wavelength light source and a single receiving system, since an additional delay component or a plurality of comparison components for compensating for a walk error of a reception signal should be applied, a more complicated circuit configuration is required, and a component for signal processing compensation is required.

Accordingly, there is a need to provide a component for preventing mutual interference according to the use of a plurality of LiDAR systems and a technical method of simplifying a circuit.

Korean Pat. Registration No. 10-2136402 (registered on Jul. 15, 2020, Multi-wavelength image LiDAR sensor device and a signal processing method thereof) discloses a LiDAR system using a plurality of wavelengths.

However, in the Patent Registration above, a multi-wavelength LiDAR sensor may be used to obtain a distance to an object and shape information and acquire information about the object, such as a color and reflectance, but there is a disadvantage that it is insufficient to solve all the problems of such a single-wavelength LiDAR system.

### SUMMARY OF THE INVENTION

The present invention is directed to providing a light detection and ranging (LiDAR) system capable of preventing interference with other surrounding LiDAR systems.

The present invention is also directed to providing a LiDAR system which does not use a separate additional circuit for preventing the occurrence of interference and compensating for interference.

The present invention is also directed to providing a LiDAR system capable of minimizing the effect of electromagnetic interference (EMI) while reducing power consumption of a LiDAR reception circuit.

According to an aspect of the present invention, there is provided a LiDAR system including a transceiver configured to generate pieces of light having different wavelengths and receive pieces of reflected light having different wavelengths reflected from a target, a beam splitter configured to divide the pieces of light having the different wavelengths into long-wavelength light having a relatively long wavelength and short-wavelength light having a relatively short wavelength, and a scan mirror configured to transmit the long-wavelength light and the short-wavelength light, which are divided by the beam splitter, to an outside and allow reflected light of the long-wavelength light and reflected light of the short-wavelength light to be incident on the transceiver through the beam splitter.

The beam splitter may include a first surface configured to reflect the long-wavelength light and a second surface disposed opposite to the first surface and configured to reflect the short-wavelength light.

A distance between optical axes of the long-wavelength light and the short-wavelength light may be adjusted by adjusting a thickness that is an interval between the first surface and the second surface.

The distance between the optical axes may be proportional to the thickness.

A vertical divergence angle of the long-wavelength light may be less than a vertical divergence angle of the short-wavelength light.

The transceiver may control a delay of a trigger timing of the long-wavelength light and the short-wavelength light to combine waveforms of the long-wavelength light and the short-wavelength light and to generate a new output light waveform.

The transceiver may include a cell array configured to convert reflected light into an electrical signal, and cells of the cell array may each receive both long-wavelength reflected light and short-wavelength reflected light.

The LiDAR system may include a filter, through which the long-wavelength reflected light and the short-wavelength reflected pass, on an upper portion of the cell array.

The transceiver may include a cell array configured to convert reflected light into an electrical signal, cells positioned at a central portion among cells of the cell array may each receive both long-wavelength reflected light and short-wavelength reflected light, and except for the cells positioned at the central portion, the remaining cells may receive short-wavelength reflected light.

In a steady state, time sections in which voltages of the long-wavelength light and the short-wavelength light are greater than or equal to a threshold voltage may be specified as reference time sections of a detection signal, and the LiDAR system may further include a processor configured to compensate for a work error using a ratio of a time section, which is detected according to a decrease or increase in a level of a reception signal, to the reference time section.

A reception circuit of the transceiver may include receivers provided in the same number as a number of channels of a multi-channel LiDAR sensor and configured to detect light, and a timing controller configured to control each of the receivers to be enabled and control the receivers at different enable times of the receivers.

The receivers may be provided as N receivers, wherein N is an integer of 4 or more, the receivers may each include a photodiode configured to detect light, and an amplifier configured to amplify a detection signal of the photodiode, and the timing controller may output a reception enable signal to an enable terminal of each of the amplifiers of the receivers.

The receivers may be provided as N receivers, wherein N is an integer of 4 or more, the receives may each include a photodiode configured to detect light, and an amplifier configured to amplify a detection signal of the photodiode, and the timing controller may output one reception enable signal synchronized with a transmission enable signal for outputting laser light to an enable terminal of the amplifier of a first receiver and may control an enable timing of the receivers through N-1 delayers configured to connect pairs of enable terminals of the amplifiers.

N reception enable signals may be sequentially delayed by a set time from a first reception enable signal to an N^{th} reception enable signal.

The N reception enable signals may include a first time section in which the amplifiers are sequentially enabled and a third time section in which the amplifiers are sequentially disabled.

The N reception enable signals may include a second time section in which all the amplifiers are maintained in an enabled state, and the second time section may be shorter than an enable time section of one reception enable signal.

The second time section may be a section from a rising edge of the N^{th} reception enable signal to a falling edge of the first reception enable signal.

The N reception enable signals may include a fourth time section from the third time section to a start of a first time section of a next frame, and in the fourth time section, all the amplifiers may be maintained in a disabled state.

### BRIEF DESCRIPTION OF THE DRAWINGS

FIG. 1 is a system configuration diagram of a light detection and ranging (LiDAR) system according to an exemplary embodiment of the present specification.

FIG. 2 is a schematic side view of long-wavelength light and short-wavelength light transmitted from the LiDAR system according to the present invention.

FIG. 3 is a schematic plan view of FIG. 2.

FIG. 4 shows arrangement state diagrams of a reception cell array applied to the present invention.

FIG. 5 is a waveform diagram for describing an example of controlling a trigger timing of short-wavelength light and long-wavelength light.

FIGS. 6 to 8 are waveform diagrams for describing a reception signal walk error compensation according to the present invention.

FIG. 9 is a circuit diagram of a reception circuit of a transceiver according to the present invention.

FIG. 10 is a timing diagram of a reception enable signal of a timing controller in FIG. 9.

FIG. 11 is a circuit diagram of a reception circuit according to another exemplary embodiment.

FIG. 12 is a diagram of a simulation result of a reception circuit.

### DETAILED DESCRIPTION OF EXEMPLARY EMBODIMENTS

Hereinafter, a light detection and ranging (LiDAR) system using light sources having different wavelengths of the present invention will be described in detail with reference to the accompanying drawings.

Exemplary embodiments of the present invention are provided to describe the present invention more completely to those having ordinary skill in the art, and the following exemplary embodiments may be modified in various different forms. Therefore, the scope of the present invention is not limited to the following exemplary embodiments. Rather, the exemplary embodiments are provided so that the present invention will be thorough and complete and will convey the concept of the present invention to those skilled in the art.

The terminology used herein is for the purpose of describing particular exemplary embodiments only and is not intended to limit the present invention. As used herein, the singular forms “a” and “an” are intended to include the plural forms as well, unless the context clearly indicates otherwise. It will be further understood that the terms “comprises” and/or “comprising” used herein specify the presence of stated shapes, numbers, steps, operations, members, elements, and/or groups thereof but do not preclude the presence or addition of one or more other shapes, numbers, steps, operations, members, elements, and/or groups thereof. As used herein, the term “and/or” includes any and all combinations of one or more of the associated listed items.

It is apparent that although the terms “first,” “second,” and the like are used herein to describe various members, regions, layers, and/or portions, these members, regions, layers, and/or portions are not limited by these terms. The terms do not mean a particular order, top and bottom, or rating but are only used to distinguish one member, region, or portion from another member, region, or portion. Accordingly, a first element, region, or portion which will be described below may indicate a second element, region, or portion without deviating from teachings of the present invention.

Hereinafter, exemplary embodiments of the present invention will be described with reference to schematic drawings illustrating the exemplary embodiments of the present invention. Throughout the drawings, for example, according to manufacturing technologies and/or tolerances, illustrated shapes may be modified. Accordingly, the exemplary embodiments of the present invention will not be understood to be limited to certain shapes of illustrated regions but will include changes in shape occurring while being manufactured.

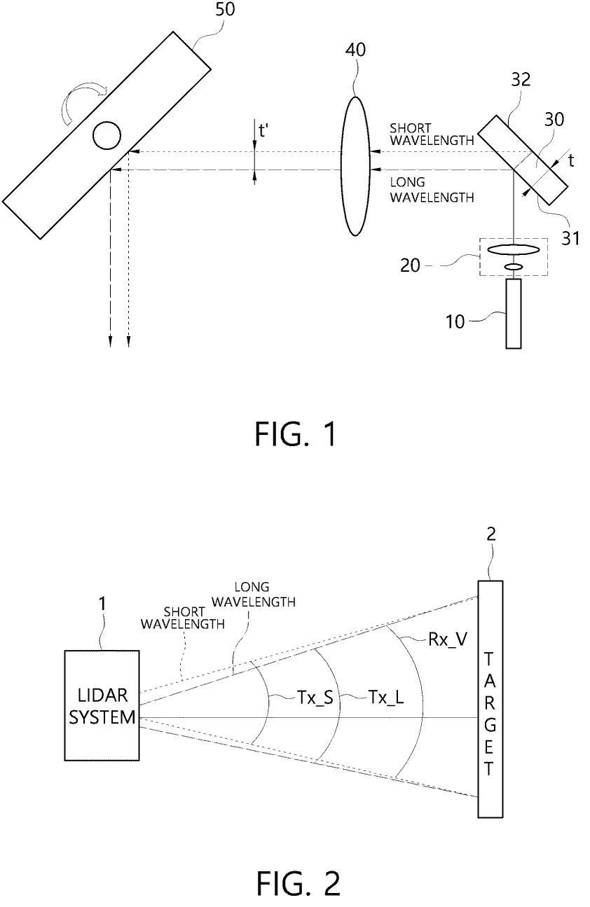

FIG. 1 is a system configuration diagram of a LiDAR system according to an exemplary embodiment of the present specification.

Referring to FIG. 1, the LiDAR system according to the present invention may include a transceiver 10 which output pieces of laser light relatively having a short wavelength and a long wavelength, a beam splitter 30 which divides light of the transceiver 10 transmitted through a lens unit 20 into long-wavelength light and short-wavelength light, and a scan mirror 50 which reflects and outputs the long-wavelength light and the short-wavelength light, which are divided by the beam splitter 30, to the outside through an incident lens 40.

Hereinafter, the configuration and operation of the LiDAR system configured as described above according to the present invention will be described in more detail.

First, the transceiver 10 includes at least one light source. In addition, the transceiver 10 is assumed to include a light receiving element, but the description of the light receiving element will be omitted.

The light source of the transceiver 10 may be provided as a single light source or a plurality of light sources that output long wavelengths and short wavelengths. In this case, long wavelengths and short wavelengths are relative concepts, and it is assumed that a specific wavelength range belongs to a laser wavelength range.

That is, as long as a wavelength is shorter than a long wavelength, the wavelength may be used as a short wavelength.

As the light source, an edge emitting laser (EEL), a vertical cavity surface emitting laser (VCSEL), or a micro lens array (MLA) may be used.

The lens unit 20 is assumed to include one or more lenses and a filter which are required to transmit and receive light.

Long-wavelength light and short-wavelength light emitted from the light source of the transceiver 10 are incident on the beam splitter 30 through the lens unit 20 and reflected by the beam splitter 30.

In this case, the beam splitter 30 reflects light output from the light source of the transceiver 10 in a direction of 90 degrees and horizontally moves each of optical axes of long-wavelength light and short-wavelength light such that a distance between the optical axes becomes a certain distance t’.

The beam splitter 30 includes a first surface 31 for reflecting a long wavelength and a second surface 32 positioned opposite to the first surface 31.

According to a thickness t of the beam splitter 30 corresponding to an interval between the first surface 31 and the second surface 32, the distance t’ between optical axes is determined.

The distance t’ between optical axes is proportional to the thickness t of the beam splitter 30.

Among long-wavelength light and short-wavelength light having a relative wavelength difference, the long-wavelength light is reflected from the first surface 31, which is an incident surface of the beam splitter 30, toward the incident lens 40, and the short-wavelength light is refracted on the first surface 31, is reflected by the second surface 32, and is incident on the incident lens 40.

In this case, the divided short-wavelength light and long-wavelength light are assumed to be parallel to each other.

The divided long-wavelength light and short-wavelength light are each reflected by the scan mirror 50 and transmitted to the outside. In the present invention, long-wavelength light advantageous for eye safety may be used as a main beam, and short-wavelength light may be used as a sub-beam.

The scan mirror 50 rotates to perform a scan for transmitting the long-wavelength light and the short-wavelength light to a set area and is driven at a certain timing.

Light transmitted through the scan mirror 50 is reflected from surrounding objects, and reflected light at this time is also divided into reflected light as long-wavelength light and reflected light as short-wavelength light and is received in a reverse of a transmission process and received by the transceiver 10.

Thus, a position of an object can be detected.

The long-wavelength light and the short-wavelength light transmitted through the scan mirror 50 will be described in more detail as follows.

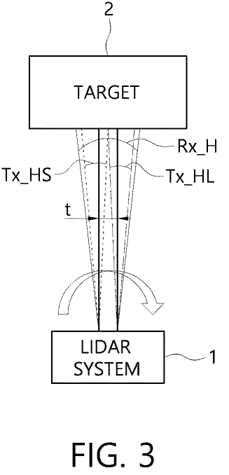

FIG. 2 is a schematic side view of long-wavelength light and short-wavelength light transmitted from the LiDAR system 1 according to the present invention, and FIG. 3 is a schematic plan view.

Referring to FIGS. 2 and 3, a basic driving state in which vertical divergence angles of the long-wavelength light and the short-wavelength light are the same is shown.

In the basic driving state, reception and transmission have the same vertical viewing angle.

In addition to such basic driving, a detection distance may be increased by narrowing a vertical divergence angle Tx_L of the long-wavelength light to converge to a central angle of view.

In this case, even when the vertical divergence angle Tx_L of the long-wavelength light is changed, since the long-wavelength light is advantageous for eye safety, a problem due to the convergence of light does not occur.

In addition, although the short-wavelength light is relatively disadvantageous for eye safety, since the short-wavelength light exhibits high sensitivity in a sensor, the short-wavelength light may be implemented to have a relatively wide vertical divergence angle Tx_S, thereby scanning a wide area at a short distance.

In the case of such modified driving, a reception vertical viewing angle Rx_V may increase as the vertical divergence angle Tx_S of the short-wavelength light increases. That is, the reception vertical viewing angle Rx_V and the vertical divergence angle Tx_S are the same angle.

In addition, in the basic driving, the long-wavelength light and the short-wavelength light have divergence angles having the same field of view and are parallel to each other by the beam splitter 30, and a distance between optical axes thereof is a positive real number rather than 0.

Accordingly, a reception horizontal viewing angle Rx_H becomes an angle including all of a horizontal divergence angle Tx_HS of the long-wavelength light, a horizontal divergence angle Tx_HL of the short-wavelength light, and the distance between optical axes.

In order to receive reflected light of the present invention having the reception vertical viewing angle Rx_V and reception horizontal viewing angle Rx_H, a plurality of reception cell arrays should be provided in the transceiver 10.

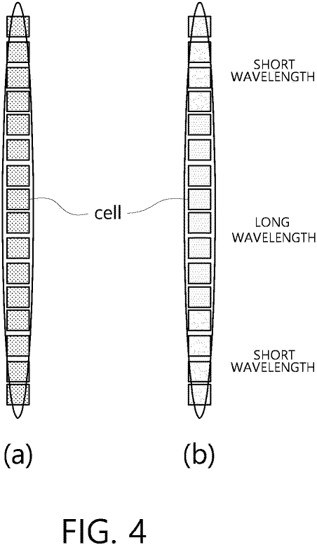

FIG. 4 shows arrangement state diagrams of a reception cell array applied to the present invention.

As shown in FIG. 4, cells constituting each receiving cell array may each receive both long-wavelength reflected light and short-wavelength reflected light. Resolution is determined according to the number of cells.

FIG. 4 illustrates a cell array in one row in a vertical direction. FIG. 4A illustrates a state in which, in a basic driving state in which a vertical divergence angle Tx_L of long-wavelength light and a vertical divergence angle Tx_S of short-wavelength light are the same, long-wavelength reflected light and short-wavelength reflected light are simultaneously received in one cell.

This is because the vertical divergence angle Tx_L of the long-wavelength light and the vertical divergence angle Tx_S of the short-wavelength light are the same as a reception vertical viewing angle Rx_V.

In addition, in a modified driving state, the vertical divergence angle Tx_L of the long-wavelength light becomes narrower than the vertical divergence angle Tx_S of the short-wavelength light. In this case, as shown in FIG. 4B, a central portion of the cell array receives long-wavelength reflected light and short-wavelength reflected light, and a side portion thereof receives only short-wavelength reflected light.

In addition, a band pass filter for a band through which both long and short wavelengths may pass may be applied to the lens unit 20 in addition to a lens.

When a cell receiving a short wavelength is specified as in the case of FIG. 4B, a filter through which only short-wavelength reflected light passes may be applied on an upper portion of the cell receiving the short wavelength, thereby improving a signal-to-noise ratio.

As described above, by adjusting a thickness of a beam splitter 30, it is possible to use an optical signal different from that of other adjacent LiDAR systems, and thus it is possible to prevent the occurrence of interference with other adjacent LiDAR systems.

In addition, it is possible to prevent the occurrence of interference between LiDAR systems having the same distance between optical axes by varying a trigger timing of long-wavelength light and short-wavelength light.

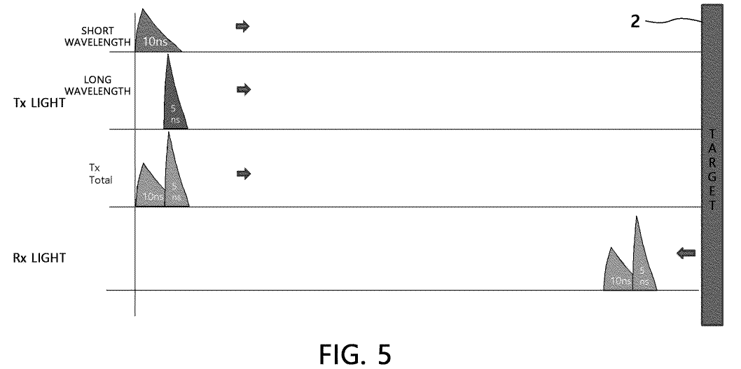

FIG. 5 is a waveform diagram for describing an example of controlling a trigger timing of short-wavelength light and long-wavelength light.

Referring to FIG. 5, a vertical divergence angle Tx_S of short-wavelength light may be controlled to be wide, and a vertical divergence angle Tx_L of long-wavelength light may be controlled to be narrow. This is a result of considering eye safety characteristics as described above.

For example, the short-wavelength light may be controlled to have a width of 10 ns, the long-wavelength light may be controlled to have a width of 5 ns, and the output of the long-wavelength light may be delayed to generate and output a desired waveform. A delay of a trigger timing may be performed by the transceiver 10.

Therefore, according to the present invention, various types of waveforms of output light can be generated through trigger timing control, which has a direct effect on reflected light reflected by a target and received by the LiDAR system.

Due to such various waveforms of reflected light, the LiDAR system can be distinguished from other LiDAR systems, and the occurrence of interference can be prevented.

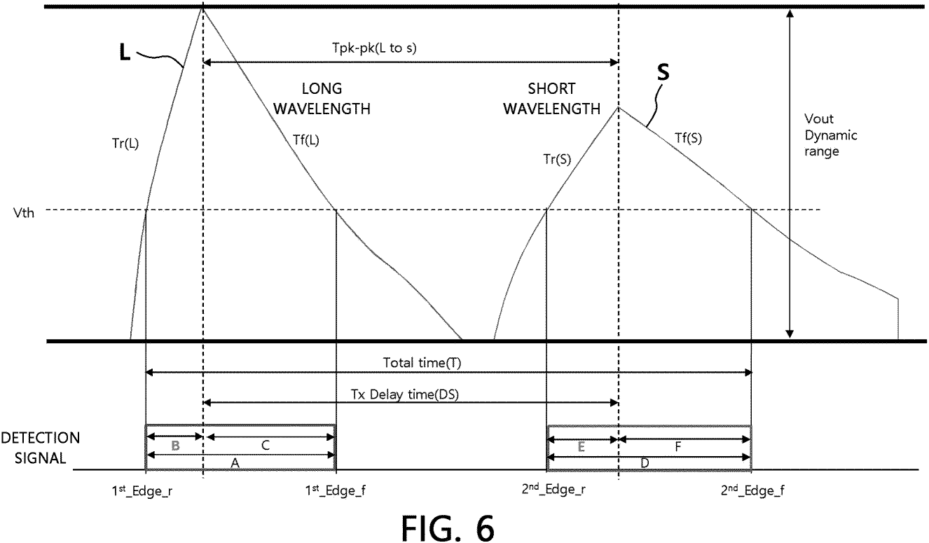

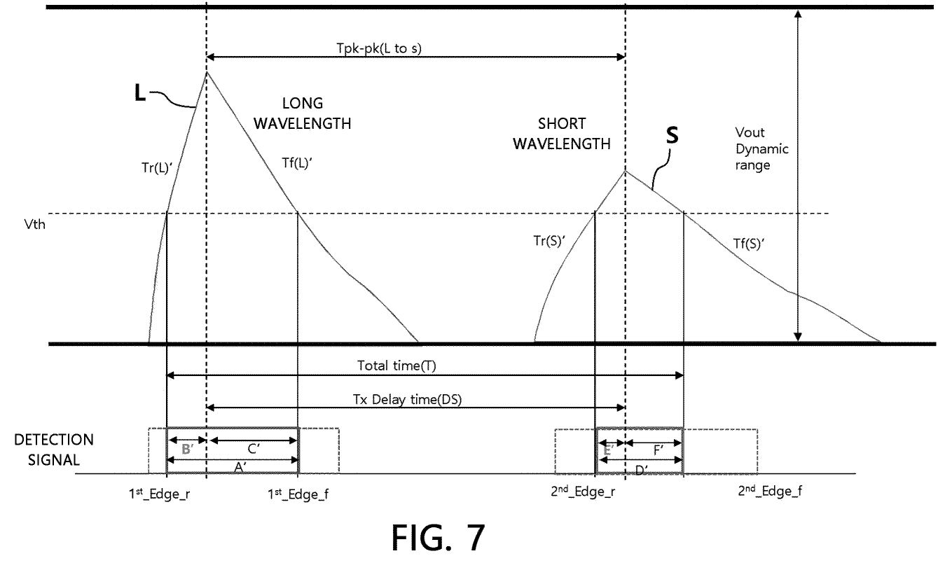

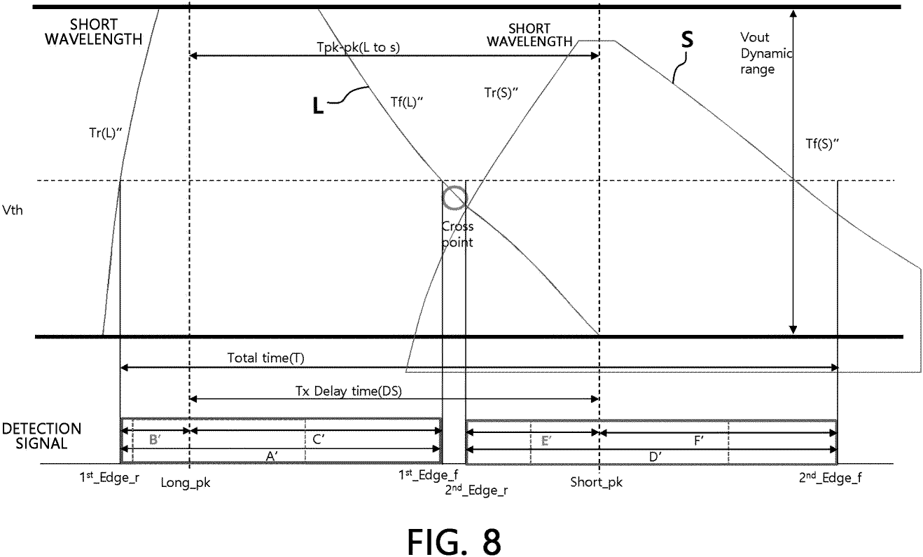

FIGS. 6 to 8 are waveform diagrams for describing a reception signal walk error compensation according to the present invention. FIG. 6 shows a reference value, FIG. 7 shows an example of compensation when signal intensity decreases, and FIG. 8 shows an example of compensation when long-wavelength reflected light is saturated.

Referring to FIG. 6, a reception cell array of the transceiver 10 may output a voltage signal upon receiving reflected light and may detect a long-wavelength reception waveform L of reflected light and a short-wavelength reception waveform S of reflected light.

Here, a threshold voltage Vth, which is a minimum detection voltage, may be set without detecting a target by detecting all signals. That is, only a voltage, which is greater than or equal to the threshold voltage Vth in the long-wavelength reception waveform L and the short-wavelength reception waveform S, is used as a detection signal.

A first edge indicates a detection signal for the long-wavelength reception waveform L, and a second edge indicates a detection signal for the short-wavelength reception waveform S.

A voltage section in which a voltage is greater than or equal to the threshold voltage of the long-wavelength reception waveform may be indicated by A, a rising section Tr(L) thereof may be indicated by B, and a falling section Tf(L) thereof may be indicated by C.

The rising section Tr(L) is a section from the threshold voltage Vth to a peak point of the long-wavelength reception waveform L, and the falling section Tf(L) is a section from the peak point to the threshold voltage Vth.

A total time T is a time from a contact point of the threshold voltage and the rising section Tr(L) of the long-wavelength reception waveform to a contact point of a falling section Tf(S) of the short-wavelength reception waveform and the threshold voltage, and a transmission (Tx) delay time DS is a time from the peak point of the long-wavelength reception waveform L to a peak point of the short-wavelength reception waveform S.

Here, the Tx delay time DS may be a delay time of the transceiver 10 as described above and may be treated as a system constant.

Similarly, at the second edge, a section between a contact point of a rising section Tr(S) of the short-wavelength reception waveform S and the threshold voltage Vth and a contact point of the falling section Tf(S) and the threshold voltage Vth is a time D of a detection signal.

E and F indicate a time from the contact point of the rising section Tr(S) and the threshold voltage Vth to the peak point of the short-wavelength reception waveform S and a time from the peak point to the contact point of the falling section Tf(S) and the threshold voltage Vth, respectively.

Except for the Tx delay time DS, A, B, C, D, E, F, and T all indicate detection values.

FIG. 7 shows an example in which a detection value is decreased compared with a state of FIG. 6. That is, FIG. 7 shows that all of A’, B’, C’, D’, E’, and F’ constituting a detection signal are decreased compared with those of FIG. 6.

In this case, when it is assumed that a ratio A’/A representing a time of a long-wavelength detection signal is α and a ratio D’/D representing a time of a short-wavelength detection signal is β, both α and β are values that are less than 1.

In this case, by using a reduction ratio, when signal intensity is decreased, a work error may be compensated for to a level of a waveform described with reference to FIG. 6. Calculation may be performed based on a long wavelength with a fast rising time.

FIG. 8 shows a case in which a peak point is difficult to detect because a waveform of a reception signal increases on the contrary to that of FIG. 7. Even in this case, it is possible to obtain a ratio α of a length of a section A’ of a long-wavelength reception waveform L in a saturated state to a length of a section A of the long-wavelength reception waveform L.

α may be a real number that exceeds 1, and in this case, an increase ratio, that is, α, may be obtained.

In addition, it is possible to obtain a ratio α of a length of a section D’ of a short-wavelength reception waveform S in a saturated state to a length of a section D of the short-wavelength reception waveform S. In this case, β is a real number that exceeds 1, and E’, F’, and the like may be obtained using β.

In a saturated state, compensation may be performed using β. This is because a correction value may be obtained using the short-wavelength reception waveform S that maintains linearity due to a relatively low peak height.

In addition, a Tx delay time DS may be set such that a cross point is positioned below a threshold voltage Vth in the drawing.

As described above, according to the present invention, an error of a reception waveform can be compensated for using two pieces of output light having different wavelengths, and compensation can be performed without using a separate compensation circuit, thereby simplifying a circuit.

Although not shown in the drawings, such compensation processing may be performed by a processor that interprets a received signal for compensation.

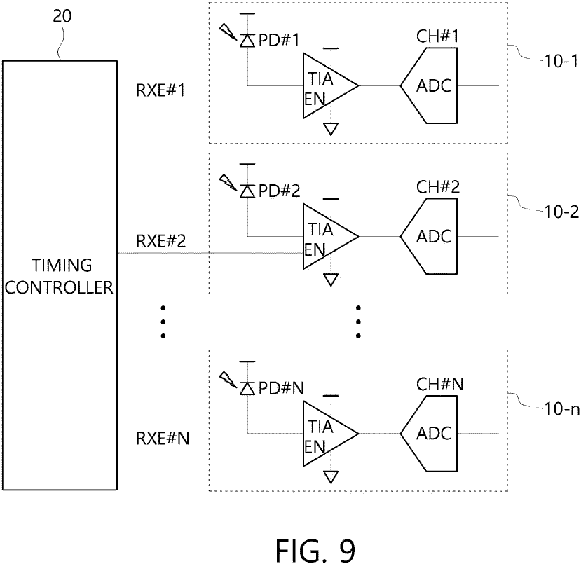

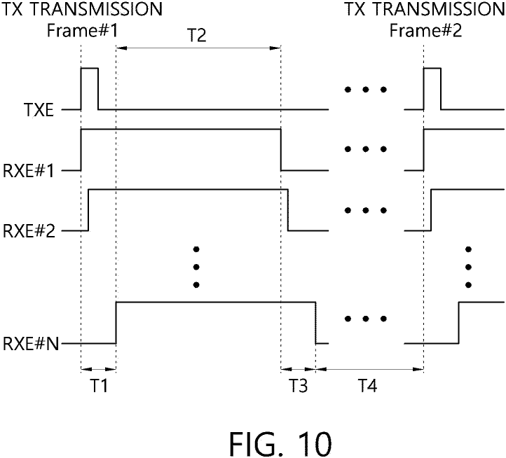

FIG. 9 is a circuit diagram of a reception circuit of a multi-channel LiDAR applied to the present invention, and FIG. 10 is a timing diagram of a reception enable signal of a timing controller in FIG. 9.

Referring to each of FIGS. 9 and 10, the reception circuit according to the present invention includes N receivers 110-1 to 110-n which each constitute a channel and receive a laser reflected from an object and a timing controller 120 which controls an enable state of each of the receivers 110-1 to 110-n.

The receivers 110-1 to 110-n may have the same configuration. For example, the receives 110-1 to 110-n may each include a photodiode PD which receives a laser reflected from an object, an amplifier which is controlled to be enabled by a reception enable signal RXE of the timing controller 120 to amplify an output of the photodiode PD, and an analog-to-digital converter ADC which converts an output of the amplifier TIA into a digital signal.

The number of channels of the reception circuit in the LiDAR is determined according to the number of the receivers 110-1 to 110-n

The timing controller 120 may provide reception enable signals RXE#1 to RXE#N at different timings to enable terminals EN of the amplifiers TIA provided in the receivers 110-1 to 110-n constituting multiple channels and may include a plurality of switching circuits.

The plurality of reception enable signals RXE#1 to RXE#N provided from the timing controller 120 have high potential sections having the same length (same cycle) as shown in FIG. 10 and are sequentially delayed by a set delay time and input to the enable terminals EN of the amplifiers TIA of the receivers 110-1 to 110-n.

According to the present invention, an enable state of the amplifiers TIA is controlled using the reception enable signal, and the amplifiers TIA are enabled in the high potential section of the reception enable signals RXE#1 to RXE#N and are disabled in a low potential section (disable section) thereof to not be operated.

N or n is a positive integer, and in consideration of the multi-channel LiDAR having at least four channels, it is assumed that N or n is an integer of 4 or more.

Therefore, according to the present invention, since the amplifier TIA is allowed to not consume power in the disable section, power consumption can be reduced, and since a method of turning power on and off at the same time is not used, the occurrence of electromagnetic interference (EMI) can be minimized.

The reception enable signals RXE#1 to RXE#N of the timing controller 120 may be described by being divided into four timing sections.

Referring again to FIG. 10, a transmission enable signal TXE is output for a certain time, and in synchronization with the transmission enable signal TXE, a first reception enable signal RXE#1 is input to the enable terminal of the amplifier TIA of a first receiver 110-1 to amplify a light receiving signal of the photodiode PD and is converted into a digital signal by the analog-to-digital converter ADC and output.

Thereafter, after a set time, a second reception enable signal RXE#2 is input to the enable terminal of the amplifier TIA of a second receiver 110-2 to operate the second receiver 110-2 which is a second channel.

Such processes may be sequentially repeated, and finally, an N^{th} reception enable signal RXE#N may be input to the amplifier TIA of an N^{th} receiver 110-n to detect light through the receiver 110-n which is an N^{th} channel.

In this way, it is assumed that a section from a rising edge of the first reception enable signal RXE#1 to a rising edge of the N^{th} reception enable signal RXE#N is defined as a first time section T1, and the first time section T1 is a section in which the respective receivers 110-1 to 110-n are enabled with a time difference by the timing controller 120.

That is, it can be understood that the channels of the reception circuit of the multi-channel LiDAR are sequentially turned on, and thus the occurrence of EMI can be minimized.

Then, a second time section T2 is substantially shorter than a high potential section of one reception enable signal, and in this case, the second time section T2 becomes a reception signal waiting section for calculating a distance to an object detected by the LiDAR sensor.

The second time section T2 starts from the rising edge of the N^{th} reception enable signal RXE#N and ends at a falling edge of the first reception enable signal RXE#1.

Next, a third time section T3 from the falling edge of the first reception enable signal RXE#1 to a falling edge of the N^{th} reception enable signal RXE#N becomes a section in which the N receivers 110-1 to 110-n constituting the respective channels are turned off with a time difference.

Even in this case, it is possible to minimize the occurrence of EMI by preventing abrupt power conversion.

After all the receivers 110-1 to 110-n are turned off, a fourth time section T4 is maintained before the transmission enable signal TXE is output in a next frame after the receivers 110-1 to 110-n maintain an off-state.

In the fourth time section T4, since all the receivers 110-1 to 110-n are in an off state, power consumption can be reduced.

Therefore, according to the present invention, it is possible to reduce power consumption in the reception circuit of the multi-channel LiDAR, prevent overheating, and minimize the occurrence of EMI through sequential enable control.

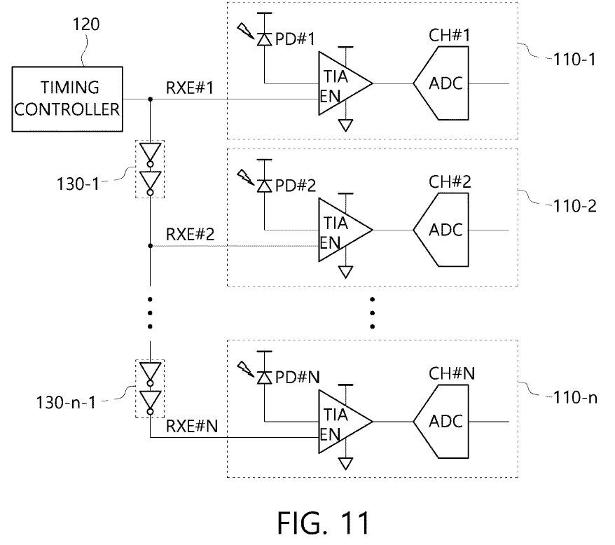

FIG. 11 is a circuit diagram of a reception circuit of a transceiver 10 of a multi-channel LiDAR according to another exemplary embodiment of the present invention.

Referring to FIG. 11, unlike the configuration described above with reference to FIG. 9, a timing controller 120 may output one reception enable signal RXE#1 according to a transmission enable signal.

Delayers 130-1 to 130-n-1 are connected in series between enable terminals EN of amplifiers TIA provided in respective receivers 110-1 to 110-n.

That is, a first delayer 130-1 connects the enable terminal of the amplifier TIA of a first receiver 110-1 and the enable terminal of the amplifier TIA of a second receiver 110-2.

In addition, a second delayer 130-2 connects the enable terminal of the amplifier TIA of the second receiver 110-2 and the enable terminal of the amplifier TIA of a third receiver 110-3.

By connecting the delayers as described above, an (N-1)^{th} delayer 130-n-1 connects the enable terminal of the amplifier TIA of an (N-1)^{th} receiver 110-n-1 and the enable terminal of the amplifier TIA of an N^{th} receiver 110-n.

A signal delay time of each of the plurality of delayers 130-1 to 130-n-1 may be assumed to be the same as a delay time of each of the reception enable signals RXE#1 to RXE#N as described above with reference to FIG. 10.

Therefore, since the plurality of delayers 130-1 to 130-n-1 are used, even when the timing controller 120 outputs only a first reception enable signal RXE#1, after the first reception enable signal RXE#1 is delayed , the reception enable signals RXE#2 to RXE#N may be generated and input to the enable terminals of the respective amplifier TIA.

The reception circuit of the exemplary embodiment shown in FIG. 11 also operates to have first to fourth time sections T1 to T4 in the same manner as in the timing diagram of FIG. 10, and thus the exemplary embodiment shown in FIG. 11 is different from the above-described example only in a circuit configuration and has the same operation effect.

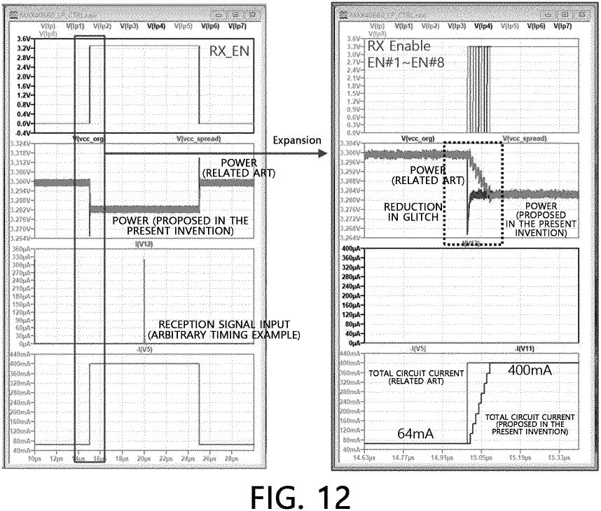

FIG. 12 shows a simulation result of a reception circuit of the multi-channel LiDAR according to the present invention.

Referring to 12, in the present invention, reception enable signals are sequentially controlled to control amplifiers TIA of receivers 110-1 to 110-n, which are each a channel, to be enabled and in the related art, power is controlled to be turned on and off, which causes a power glitch phenomenon.

However, in the present invention, power glitches can be alleviated by controlling a current change relatively gently. Glitches are known to cause power EMI, and thus, the present invention can reduce power EMI.

As can be seen from a graph of a total current change, in both circuits of the present invention and the related art, a current is changed from 64 mA to 400 mA. However, it can be seen that the current changes abruptly in the related art, but the current changes with a relatively gentle slope over time in the present invention.

The present invention has an effect in which two pieces of light having different light source wavelengths are used, and a distance between optical axes of the two pieces of light is adjusted to allow each LiDAR system to have a unique emission pattern, thereby preventing the occurrence of an interference phenomenon with other adjacent LiDAR systems.

In addition, the present invention has an effect of avoiding interference by differentiating pulse widths, intensities, delay times, and the like of two pieces of lights having different wavelengths.

As such, in the present invention, the occurrence of an interference phenomenon is prevented by at least adjusting a distance between optical axes of long-wavelength light and short-wavelength light, thereby compensating for a work error without using a separate additional element.

In addition, since light emitted by a light source for one measurement is divided into long-wavelength light and short-wavelength light and has a certain delay time, a peak time based on one-time emission is relatively low, which has a more advantageous effect on eye safety.

In addition, the present invention has an effect of changing a configuration of a reception circuit of a transceiver to reduce power consumption and minimize an influence of EMI.

It should be obvious to those skilled in the art to which the present invention pertains that the present invention is not limited to the above-described exemplary embodiments and can be variously changed and modified without departing from the technical spirit of the present invention.

1. A light detection and ranging (LiDAR) system comprising:
a transceiver configured to generate pieces of light having different wavelengths and receive pieces of reflected light having different wavelengths reflected from a target;
a beam splitter configured to divide the pieces of light having the different wavelengths into long-wavelength light having a relatively long wavelength and short-wavelength light having a relatively short wavelength; and
a scan mirror configured to transmit the long-wavelength light and the short-wavelength light, which are divided by the beam splitter, to an outside and allow reflected light of the long-wavelength light and reflected light of the short-wavelength light to be incident on the transceiver through the beam splitter.

2. The LiDAR system of claim 1, wherein the beam splitter includes a first surface configured to reflect the long-wavelength light and a second surface disposed opposite to the first surface and configured to reflect the short-wavelength light.

3. The LiDAR system of claim 2, wherein a distance between optical axes of the long-wavelength light and the short-wavelength light is adjusted by adjusting a thickness that is an interval between the first surface and the second surface.

4. The LiDAR system of claim 3, wherein the distance between the optical axes is proportional to the thickness.

5. The LiDAR system of claim 2, wherein a vertical divergence angle of the long-wavelength light is less than a vertical divergence angle of the short-wavelength light.

6. The LiDAR system of claim 2, wherein the transceiver controls a delay of a trigger timing of the long-wavelength light and the short-wavelength light to combine waveforms of the long-wavelength light and the short-wavelength light and to generate a new output light waveform.

7. The LiDAR system of claim 6, wherein:
the transceiver includes a cell array configured to convert reflected light into an electrical signal; and
cells of the cell array each receive both long-wavelength reflected light and short-wavelength reflected light.

8. The LiDAR system of claim 7, comprising a filter, through which allows the long-wavelength reflected light and the short-wavelength reflected pass, on an upper portion of the cell array.

9. The LiDAR system of claim 6, wherein:
the transceiver includes a cell array configured to convert reflected light into an electrical signal;
cells positioned at a central portion among cells of the cell array each receive both long-wavelength reflected light and short-wavelength reflected light; and
except for the cells positioned at the central portion, the remaining cells receive short-wavelength reflected light.

10. The LiDAR system of claim 6, wherein:
in a steady state, time sections in which voltages of the long-wavelength light and the short-wavelength light are greater than or equal to a threshold voltage are specified as reference time sections of a detection signal; and
the LiDAR system further includes a processor configured to compensate for a work error using a ratio of a time section, which is detected according to a decrease or increase in a level of a reception signal, to the reference time section.

11. The LiDAR system of claim 1, wherein:
a reception circuit of the transceiver includes:
receivers provided in the same number as the number of channels of a multi-channel LiDAR sensor and configured to detect light; and
a timing controller configured to control each of the receivers to be enabled and control the receivers at different enable times of the receivers.

12. The LiDAR system of claim 11, wherein:
the receivers are provided as N receivers, wherein N is an integer of 4 or more;
the receivers each include a photodiode configured to detect light and an amplifier configured to amplify a detection signal of the photodiode; and
the timing controller outputs a reception enable signal to an enable terminal of each of the amplifiers of the receivers.

13. The LiDAR system of claim 11, wherein:
the receivers are provided as N receivers, wherein N is an integer of 4 or more;
the receivers each include a photodiode configured to detect light and an amplifier configured to amplify a detection signal of the photodiode; and
the timing controller outputs one reception enable signal synchronized with a transmission enable signal for outputting laser light to an enable terminal of the amplifier of a first receiver and controls an enable timing of the receivers through N-1 delayers configured to connect pairs of enable terminals of the amplifiers.

14. The LiDAR system of claim 12, wherein N reception enable signals are sequentially delayed by a set time from a first reception enable signal to an N^{th} reception enable signal.

15. The LiDAR system of claim 14, wherein the N reception enable signals include a first time section in which the amplifiers are sequentially enabled and a third time section in which the amplifiers are sequentially disabled.

16. The LiDAR system of claim 15, wherein:
the N reception enable signals include a second time section in which all the amplifiers are maintained in an enabled state; and
the second time section is shorter than an enable time section of one reception enable signal.

17. The LiDAR system of claim 16, wherein the second time section is a section from a rising edge of the N^{th} reception enable signal to a falling edge of the first reception enable signal.

18. The LiDAR system of claim 15, wherein:
the N reception enable signals include a fourth time section from the third time section to a start of a first time section of a next frame; and
in the fourth time section, all the amplifiers are maintained in a disabled state.
